(19) United States
(12) Patent Application Publication
(10) Pub. No.: US 2008/0113249 A1
(43) Pub. Date: May 15, 2008

(54) Fuel cell system

(76) Inventors: Joon-soo Bae, Suwon-si (KR); Tong-jin Park, Suwon-si (KR)

Correspondence Address: ROBERT E. BUSHNELL, 1522 K STREET NW, SUITE 300, WASHINGTON, DC, 20005-1202, US

(21) Appl. No.: 11/984,108

(22) Filed: Nov. 13, 2007

(30) Foreign Application Priority Data
Nov. 14, 2006 (KR) 10-2006-0112225

(51) Int. Cl. H01M 2/00; H01M 8/00

(52) U.S. Cl. 429/34

(57) ABSTRACT

Disclosed is a fuel cell system having a filter module that prevents the impurity contained in a fuel from entering into a fuel cell of the fuel cell system. The fuel cell system of the present invention includes a cartridge combination portion connected to a fuel cartridge and receiving a fuel from the cartridge, a pump receiving the fuel from the cartridge combination portion and transferring the fuel to the fuel cell, and a means for intercepting the impurity of the fuel and disposed between the cartridge combination and the pump.

### CLAIM OF PRIORITY

This application makes reference to, incorporates the same herein, and claims all benefits accruing under 35 U.S.C. §119 from an application for FUEL CELL SYSTEM earlier filed in the Korean Intellectual Property Office on the 14^{th} of Nov. 2006 and there duly assigned Serial No. 10-2006-0112225.

### BACKGROUND OF THE INVENTION

1. Field of the Invention

The present invention relates to a fuel cell system having a means to prevent impurity from flowing into a fuel cell of the fuel cell system.

2. Description of the Related Art

In general, a fuel cell is a power generating system that directly transforms chemical energy into electric energy by an electrochemical reaction between hydrogen and oxygen. In order to supply hydrogen to a fuel cell system, pure hydrogen can be directly used, or methanol, ethanol, natural gas or the like materials can be reformed to produce hydrogen to be supplied. Further, in order to supply oxygen to the fuel cell system, pure oxygen can be directly used, or oxygen contained in the air can be supplied by an air pump or the like apparatus.

The fuel cell is classified into a polymer electrolyte membrane fuel cell or a direct methanol fuel cell which operate at room temperature or a temperature of less than 100° C., a phosphoric acid fuel cell, which operates at a temperature of 150° C.˜200° C., a molten carbon fuel cell which operates at a temperature of 600° C.˜700° C., a solid oxide fuel cell which operates at a high temperature of more than 1000, and so on. These fuel cells operate on basically the same principles, but they are different in the kind of fuel, catalyst, electrolyte, and other parameters.

Among the fuel cells, direct methanol fuel cell (DMFC) uses liquid methanol of high concentration after mixing with water instead of hydrogen for direct fuel. The direct methanol fuel cell has lower output density than fuel cell using hydrogen for a direct fuel, but methanol used for fuel has high energy density per volume and is easy for storage. Therefore, it is advantageous to the condition which low power and long driving are required. Further, the DMFC is advantageous to the miniaturization since it does not need a reformer generating hydrogen by reforming fuel and the like additional apparatus.

The DMFC comprises an electrolyte membrane, and a membrane electrode assembly (MEA) constituted of an anode electrode and a cathode electrode contacted to both sides of the electrolyte membrane. A fluoridation polymer and etc. are used for the electrolyte membrane, however, when methanol of high concentration is used for fuel, crossover phenomenon, which methanol permeates the electrolyte membrane occurs because methanol penetrates quickly the fluoridation polymer. Accordingly, in order to lower concentration of methanol, a fuel mixed with methanol and water is supplied to the fuel cell system.

Meanwhile, the polymer electrolyte membrane fuel cell (PEMFC) uses hydrogen generated by reforming methanol, ethanol, natural gas, or other fuels, and has advantages when compared with other types of fuel cells because its output performance is excellent, its operation temperature is low, and it starts and responds quickly. Thus, the PEMFC can be widely used as a distributed power source for a house and a public building, a small portable power source for a portable electronic apparatus, as well as a transportable power source for a vehicle.

PEMFC may generate a reformed gas containing abundant hydrogen required to generate electricity through catalyst reactions such as steam reforming (SR), water gas shift (WGS), and etc., and remove carbon monoxide contained in the reformed gas and poisoning a catalyst of the fuel cell. In the catalyst reaction water is necessary, so mixed fuel generated by mixing the fuel with water is supplied to the reformer.

Among the methods for refilling the fuel, a fuel cell system using a method of cartridge type fuel supply is preferable for convenience of the users. Particularly, in a fuel cell system using liquefied fuel such as DMFC the method of cartridge type supply has been researched as an influential method. However, the method of cartridge type fuel supply has the high risk that external impurity in a cartridge and a combination part of the fuel cell system flow into the inside of the fuel cell system by poor products and carelessness of the users when exchanging the cartridge.

The external impurity flowed into the fuel cell system have bad influence upon each component of the fuel cell system. Particularly, the bad influence is more serious to miniaturized pump equipment such as a fuel cell MEA or a diaphragm pump.

As a prior art to prevent inflow of the impurity, a method that a filter is contained in a fuel cartridge or a filter is contained in front of a stack in a fuel cell system is proposed.

FIG. 1 illustrates a fuel cell system with a means for removing the impurity in order to prevent the stack of a fuel cell from being damaged by the impurity. A fuel stored in a fuel tank 7 is supplied to a fuel mixer 1 in which the fuel is mixed with a discharged fuel that is supplied through a discharge supply line 10. The fuel is supplied to a fuel cell stack 4 through fuel supply line 11. A feed pump 2 and impurity removing device 3 are disposed between the fuel mixer 1 and fuel cell stack 4. Air is supplied to the fuel cell stack 4 through air blower 8 and air filter 6. The discharge from the fuel cell stack 4 is supplied to a separator 5 in which fuel is separated from air, and the separated fuel is supplied to the fuel mixer 1 through the discharge supply line 10.

As shown in FIG. 1, inefficient operation and damage of the fuel cell stack 4 maybe prevented by providing impurity removing device 3 on a path which supplies the fuel from a feed pump 2 to the fuel cell stack 4. However, in the case of a fuel cell system in FIG. 1, the means for removing the impurity is removable, but a specific method is not presented in order to be removable. Therefore a large amount of expense and volume increase can be caused to make it possible for the means for removing the impurity 3 disposed in the middle of the path of fluid to be removable. Further, there may be a problem that the damage of the feed pump 2 or a fuel pump (not shown) is not prevented from the impurity since the means for removing the impurity 3 is positioned in an output of the feed pump 2.

### SUMMARY OF THE INVENTION

The present invention is designed to solve the above problems, and an objective of the present invention is to provide a fuel cell system capable of preventing an inflow of the impurity to therein.

An objective of the present invention is to provide a fuel cell system capable of preventing an inflow of the impurity to the inside of the fuel cell system by carelessness when exchanging the fuel cartridge. Another objective of the present invention is to provide a fuel cell system capable of preventing the damage of the pump by inflow of the impurity. Also, another objective of the present invention is to provide a fuel cell system capable of exchanging easily a means for intercepting the impurity, which intercepts an inflow of the impurity into the fuel cell system.

The fuel cell system of the present invention to achieve the above objectives includes a cartridge combination portion connected to a fuel cartridge and receiving a fuel from the fuel cartridge, a pump receiving the fuel from the cartridge combination portion and transferring the fuel to a fuel cell of the fuel cell system, and a means for intercepting the impurity mounted between the cartridge combination portion and the pump and intercepting impurity contained in the fuel.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicated the same or similar components, wherein:

FIG. 1 is a block view illustrating a structure of a fuel cell system;

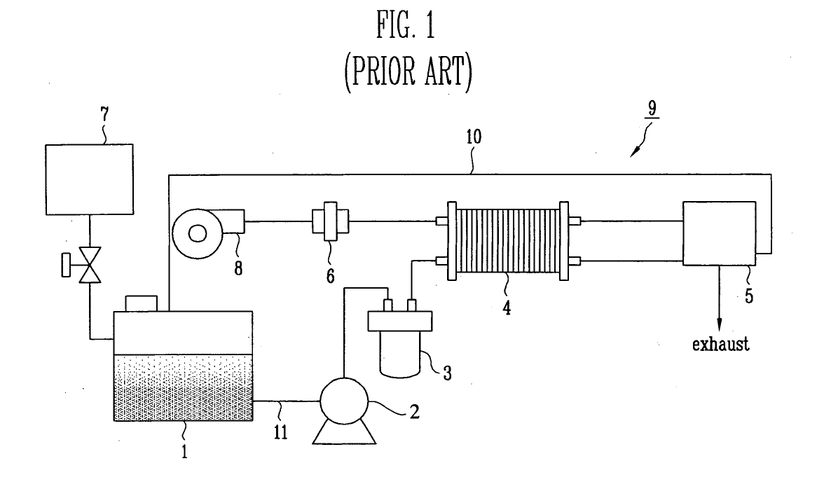

FIG. 2 is a block view illustrating a structure of a fuel cell system according to an embodiment of the present invention; and

FIG. 3a and 3b are a perspective view illustrating an embodiment of a filter module applicable to the fuel cell system in FIG. 2.

### DETAILED DESCRIPTION OF THE EXEMPLARY INVENTION

Hereinafter, certain exemplary embodiments according to the present invention will be described with reference to the accompanying drawings. Here, when a first element is described as being coupled to a second element, the first element may be not only directly coupled to the second element but may also be indirectly coupled to the second element via a third element. Further, elements that are not essential to the complete understanding of the invention are omitted for clarity. Also, like reference numerals refer to like elements throughout.

In description of the present invention, for example, the term, a fuel cell stack is used, but it is to use the term conveniently. The fuel cell stack used for description of the present invention is a general concept including a stack consisting of the laminated type unit cells, a stack consisting of plate type unit cells, and a unit stack including a singular unit cell.

Also, in an embodiment below DMFC is specifically described having a mixing tank to recover and recycle a discharge of the fuel cell stack, but the idea of the present invention is applied to a system, which is most widely used. The idea of the present invention may be applied to a system, which supplies directly the fuel of the fuel cartridge to the fuel cell stack.

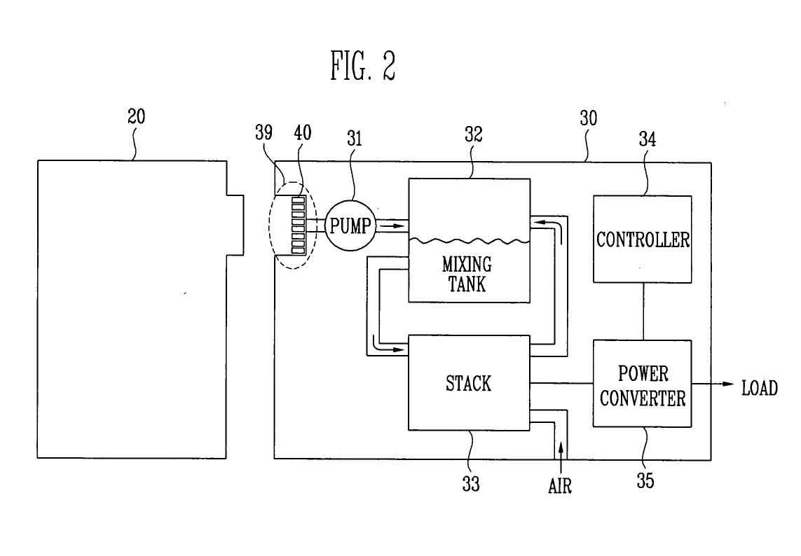

The fuel cell system 30 of the embodiment illustrated in FIG. 2 includes a fuel cell stack 33 generating electricity through an electrochemical reaction between hydrogen and oxygen, a cartridge combination portion 39 connected to a fuel cartridge 20 and receiving a fuel from the fuel cartridge 20, a fuel pump 31 receiving the fuel from the cartridge combination portion 39 and transferring the fuel to the fuel cell, a mixing tank 32 mixing the fuel flowed through the fuel pump 31 and a discharge of the fuel cell stack 33, and supplying a compound to the fuel cell stack 33; and a filter module 40 mounted between the cartridge combination portion 39 and the fuel pump 31. The filter module 40 removes impurity on an inflow path of the fuel from the cartridge combination portion 39 to the pump 31.

Meanwhile, the fuel cell system 30 of the embodiment may further include a condenser (not shown) condensing gas and recovering water and non-reacted methanol. Also, the fuel cell system 30 may further include a feed pump (not shown) to transfer mixed fuel to an anode of the fuel cell stack 33, an air pump (not shown) to blow air into a cathode, and may further include the fuel pump 31 and/or a driving controller 34 to control operation of the feed pump, the condenser, and the air pump depending on a degree of development of the fuel cell system.

Also, the fuel cell system 30 may further include a power converter 35 converting a voltage/current of the power generated through an electrochemical reaction for its use, transferring it to an external load, and supplying some of the power as the driving power of an internal constituent such as the driving controller 34.

In the case that the fuel is a methanol aqueous solution, a reaction formula showing a reaction of the fuel cell stack 33 is shown in Formula 1.

anode: CH₃OH+H₂O→CO₂+6H⁺+6e⁻

cathode: 3/2O₂+6H⁺+6e⁻→3H₂O

total reaction: CH₃OH+3/2O₂+H₂O→CO₂+3H₂O+electricity+heat Formula 1

Referring to Formula 1, if a methanol aqueous solution is supplied to an anode electrode of a membrane electrode assembly (MEA) of the fuel cell stack 33 and air is supplied to a cathode electrode, the methanol aqueous solution flows to the anode electrode and is resolved into an electron, hydrogen ion, and etc. on a catalyst layer. Hydrogen ion moves through an electrolyte membrane of the MEA, and water is generated by mixing the hydrogen ion generated from the cathode electrode and the electron moving through an external wire. And, an effluence of the anode (non-reacted fuel, carbon dioxide etc.) and an effluence of the cathode (water, air etc.) are discharged from the anode and the cathode. According to the above process, electricity is generated by an electron moving through an external wire, and heat is incidentally generated by a chemical reaction between mixed fuel and oxygen.

A methanol of high concentration is stored in the fuel cartridge 20 functioning as a fuel tank, and if the cartridge 20 and the fuel cell 30 join together, the fuel cell 30 may receive the fuel through an outlet of the fuel cartridge by using the fuel pump 31. The cartridge combination portion 39 is relief shape, and the relief shape is a part to remain a mechanical combination with the cartridge. The filter module 40 is mounted to be removable from the inside of the cartridge combination portion to the outside, so it is capable of achieving a low cost and obtaining a removable structure more easily.

The mixing tank 32 makes a methanol aqueous solution of proper concentration by mixing the fuel of high concentration received from the cartridge 20 and a discharge of the cathode of the fuel cell stack 33, and supplies it to the anode. In generally not only a discharge of the cathode of the fuel cell stack 33 but also a discharge of the anode is used for mixing.

The fuel pump 31, which is to transfer the fuel stored in the fuel cartridge 20 to the mixing tank 32, can be a diaphragm pump in the aspect of cost performance ratio in a case of the small sized potable fuel cell system. However, if the size of impurity particle is big, flow in the diaphragm pump, the performance and the durability of the pump deteriorate.

According to the principles of the present invention, the filter module 40 functions as a means for intercepting the impurity by preventing the impurity from entering from the cartridge combination portion 39 into the inside of the fuel cell system, particularly into the fuel pump 31.

The impurity maybe suspended solids included in the fuel stored in the fuel cartridge 20 by a shortage generated from a process for manufacturing the fuel cartridge, a part of materials for constituting an internal wall of the fuel cartridge 20 which is separated from the fuel cartridge, or materials which is entered to the cartridge combination portion 39 by carelessness of the user when exchanging the cartridge. Also, the impurity may be directly entered by the gravity and an electrostatic force into the inside of the fuel cell system when replacing, or entered with the fuel, which is pumped according to the operation of the fuel cell system.

In a system including a filter in the cartridge, the impurity generated during an exchange of the cartridge may not be removed, but the filter module of the embodiment of the present invention can intercept the impurity generated during an exchange of the cartridge

Meanwhile, the filter module 40 of the embodiment is preferably installed to be removable, and accordingly the filter module, which has relatively a short life span, may be replaced easily. That is, the filter module 40 of the embodiment is positioned in the cartridge combination portion 39 where the fuel cartridge 20 and the fuel cell system are combined, and since the place is a part coupled with the outside of the fuel cell system, the replacement of components is easy.

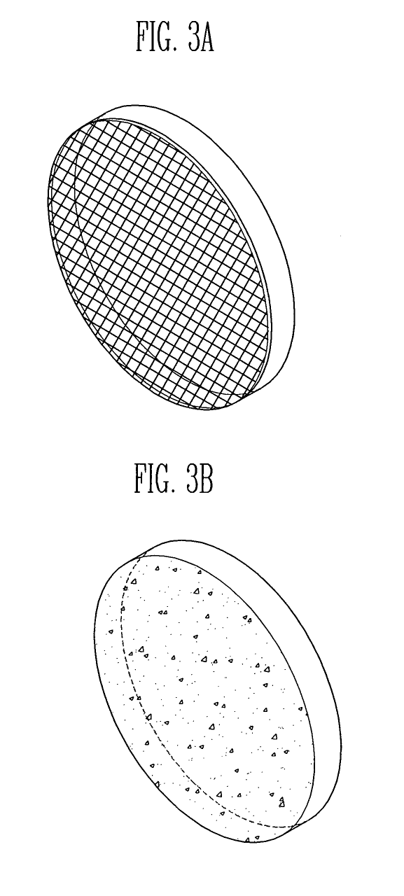

In a specific method for manufacturing the filter module 40 whose production cost is cheap, there are a metal net as shown in FIG. 3a and a porous sponge material as shown in FIG. 3b. It is important that the size of a through hole is smaller than the size of impurity particles in order to intercept the impurity regardless of its shape.

The fuel cell system with a means for intercepting impurity of the present invention has an advantage, which prevents the impurity from entering into the fuel cell system, and in particular, it prevents the impurity from accidentally entering into the fuel cell system while exchanging the fuel cartridge. Also, the fuel cell system of the present invention has an advantage, which can easily replace the means for intercepting the impurity.

Although a few embodiments of the present invention have been shown and described, it would be appreciated by those skilled in the art that changes might be made in this embodiment without departing from the principles and spirit of the invention, the scope of which is defined in the claims and their equivalents.

What is claimed is:

1. A fuel cell system comprising;
a cartridge combination portion connected to a fuel cartridge and receiving a fuel from the fuel cartridge;
a pump receiving the fuel from the cartridge combination portion and transferring the fuel to a fuel cell included in the fuel cell system; and
a filter module mounted in a flow path of the fuel between the cartridge combination portion and the pump, the filter module intercepting impurity contained in the fuel.

2. The fuel cell system as claimed in claim 1, wherein the filter module is installed to be removable.

3. The fuel cell system as claimed in claim 2, wherein the filter module is directly installed on the cartridge combination portion.

4. The fuel cell system as claimed in claim 1, wherein the filter module includes a filter for fluid, the filter having a through hole whose size is smaller than the size of impurity.

5. The fuel cell system as claimed in claim 1, wherein the filter module includes a net.

6. The fuel cell system as claimed in claim 1, further comprising:
a mixing tank mixing the fuel flowed through the fuel pump and a discharge of the fuel cell, the mixing tank supplying the mixture of the fuel and the discharge to the fuel cell.

7. The fuel cell system as claimed in claim 1, wherein the fuel includes methanol.

8. The fuel cell system as claimed in claim 1, wherein the pump includes a diaphragm pump.
